(19) United States
(12) Patent Application Publication
(10) Pub. No.: US 2024/0159898 A1
(43) Pub. Date: May 16, 2024

(54) ULTRASONIC SENSOR SYSTEM HAVING A VARYING SOLID ANGLE

(71) Applicant: Robert Bosch GmbH, Stuttgart (DE)

(72) Inventors: Juergen Schmidt, Sindelfingen (DE); Matthias Boecker, Saarbrücken (DE); Michael Schumann, Stuttgart (DE); Timo Pfeiffer, Leinfelden-Echterdingen (DE)

(21) Appl. No.: 18/548,406

(22) PCT Filed: Sep. 28, 2022
(86) PCT No.: PCT/EP2022/076931

§ 371 Date: Aug. 30, 2023

(30) Foreign Application Priority Data
Oct. 11, 2021 (DE) 10 2021 211 588.8

(51) Int. Cl. G01S 15/931

(52) U.S. Cl. CPC G01S 15/931; G01S 2015/932

(57) ABSTRACT

A method for operating at least one ultrasonic sensor array, in particular, using a control unit. The ultrasonic sensor array is driven to generate sonic echos. Reflected sonic echos are received by the ultrasonic sensor array, in order to generate measurement data on the basis of the received sonic echos. The ultrasonic sensor array is driven to generate and receive sonic echos in such a manner, that a horizontal and/or vertical solid angle of a detecting range is changed. A control unit, a computer program, and a machine-readable storage medium, are also described.

### FIELD

The present invention relates to a method for operating at least one ultrasonic sensor array. In addition, the present invention relates to a control unit, a computer program, and a machine-readable storage medium.

### BACKGROUND INFORMATION

Ultrasonic sensors are often used in the automotive sector, in order to simplify the parking operation for the driver. The ultrasonic sensors used for this have a fixed opening angle, that is, solid angle, of the scanning range and may only function optimally within a certain distance range. In particular, ground reflections occur in the case of short distances; the ground reflections being a function of the installation height and installation angle of the ultrasonic sensor. These ground reflections are registered by the ultrasonic sensor, which means that detection gaps occur for objects outside of this range. Depending on the design of the system, such ground reflections may be suppressed by compensation mechanisms. However, this also prevents the detection of weakly reflecting objects.

German Patent Application No. DE 10 2015 101 266 A1 describes a vehicle assistance system for lateral detection of objects with the aid of optical sensors. The sensor system includes a plurality of receive channels having different detecting ranges.

German Patent Application No. DE 10 2006 004 865 A1 describes a parking assistance system, in which a first sensor takes the form of a transmitting and receiving unit and a second sensor takes the form of a receiving unit. The sensors have different detecting ranges, which overlap in some areas.

Such systems require an increased number of ultrasonic sensors, which additionally result in increased evaluation expenditure.

### SUMMARY

An object of the present invention may be regarded as providing an improved method of ultrasonic-based measurement of distances.

This object may be achieved with the aid of features of the present invention. Advantageous refinements of the present invention are disclosed herein.

According to one aspect of the present invention, a method of operating at least one ultrasonic sensor array is provided. The method may preferably be executed by a control unit, which is connected to at least one ultrasonic sensor array in a manner allowing transmission of data. In this context, the control unit may drive the ultrasonic sensor array to generate sonic echos and to receive measurement data generated by the ultrasonic sensor array.

According to an example embodiment of the present invention, in one step, the ultrasonic sensor array is driven to generate sonic echos. Sonic echos reflected from a scanning range are received by the ultrasonic sensor array, in order to generate measurement data on the basis of the sonic echos received. Such ultrasonic sensor arrays are made up of a plurality of ultrasonic sensors and/or partial sensors, which are installed, for example, in a conventional housing. Such partial sensors may be driven by the control unit independently of each other, to generate sonic echos and/or to receive reflected sonic echos. This may be accomplished directly by the control unit or by an interconnected driver and/or input stage electronics, e.g., for the amplification of the received signals or for the analog-to-digital conversion of the received signals.

The ultrasonic sensor array is preferably driven to generate and receive sonic echos in such a manner, that a horizontal and/or vertical solid angle of a detecting range is changed. In this connection, the solid angle may be changed cyclically or continuously, in order to scan different distances and depths of the scanning range, using sonic echos. The solid angle, which the ultrasonic sensor array scans, using sonic echos, and from which the sonic echos are received, may be varied along a horizontal direction and/or along a vertical direction.

A solid angle, into which the ultrasonic sensor array directs the sonic echos, and a solid angle, from which the ultrasonic sensor array receives the reflected sonic echos, may preferably be equal to each other or differ from each other. The corresponding directional characteristic may be set and varied by the control unit.

Detection gaps may be reduced by the method, for example, for contour protection, since due to the variably adjusted solid angle, ground reflections may no longer overlap sections of the scanning range permanently. In addition, ramps, steps, or even complex scenes having ambiguous measurement data may be reliably resolved, using varying solid angles. An ultrasonic sensor array operated by the method may also be utilized to classify objects by height.

According to a further aspect of the present invention, a control unit is provided; the control unit being configured to execute the method. The control unit may be, for example, a control unit on the vehicle, a control unit outside of the vehicle, or a server unit, such as a cloud system, outside of the vehicle.

In addition, according to one aspect of the present invention, a computer program is provided, which includes commands that, in response to the execution of the computer program by a computer or a control device, cause it to implement the method of the present invention. According to a further aspect of the present invention, a machine-readable storage medium is provided, in which the computer program of the present invention is stored. The machine-readable storage medium may also take the form of an internal or external storage unit of the control unit.

Current parking systems may be optimized, and highly automated and/or autonomous driving functions may be safeguarded, by the method of the present invention.

In one exemplary embodiment of the present invention, the ultrasonic sensor array is driven to generate and receive sonic echos from a detection range, using a wide solid angle and a subsequent, reduced solid angle. Such a sequence of angular variation of the solid angle may allow short and tall objects to be distinguished. In this context, a scanning range and/or a scene may be captured, using a wide solid angle, and subsequently scanned, using a markedly reduced opening angle and/or solid angle. Using the reflections from the two measurements, a tall object may be distinguished from a short object. In particular, the plausibility of a tall object may be checked, in particular, by measuring and/or scanning the scanning range, using a small solid angle.

According to a further specific embodiment of the present invention, the ultrasonic sensor array is driven to generate and receive sonic echos from a detecting range, using a solid angle that is varied in steps. Using this measure, the solid angle may be decreased or increased in predefined angular steps, in order to prevent detection gaps. In particular, steps or ramps due to the ground reflections may be identified by scanning the scanning range, using varied opening angles.

According to a further exemplary embodiment of the present invention, the ultrasonic sensor array is driven to generate and receive sonic echos from a detecting range, using a solid angle that is varied continuously. Consequently, objects having a small height and objects having a large height may be distinguished. By scanning the detecting range, using a varied opening angle, a plurality of object distances, such as one object distance per opening angle, may be generated.

According to a further exemplary embodiment of the present invention, the different, continuously adjusted solid angles of the detecting range of the generated sonic waves overlap in sections; ascertained data from overlapping solid angles being excluded in light of the generated measurement data. Through this, free spaces and obstacles may be detected within the resulting segments in a fine-grained manner, with the aid of superposition and the exclusion principle of the distances and opening-angle information.

Steps and ramps may also be located by varying the opening angle. Since there is an expected ground reflection for each Substitute Specification opening angle, the obtained echo distances may be compared to the reflection points, and a ramp or step may be derived.

According to a further specific embodiment of the present invention, the solid angle is first changed, after the ultrasonic sensor array is driven to generate sonic echos and receives reflected sonic echos from a scanning range. By this measure, at least one measurement is made at a set solid angle, before the solid angle is varied again. In this context, a measurement corresponds to at least one transmitting step and at least one receiving step. A solid angle is only changed after at least one transmitting step and at least one receiving step within the solid angle, which means that at least one further transmitting step and at least one further receiving step may be carried out. This may take place at a plurality of different solid angles, in order to compensate, for example, for detection gaps, or to be able to scan different types of surfaces precisely.

According to a further exemplary embodiment of the present invention, the solid angle of the detecting range is changed by a digitally adjustable, directional characteristic. This may allow the solid angle to be changed rapidly and efficiently within very short time intervals.

In the following, preferred exemplary embodiments of the present invention are explained in greater detail in light of highly simplified, schematic representations.

### BRIEF DESCRIPTION OF THE DRAWINGS

FIG. 1 shows a schematic flow chart for illustrating a method according to a first specific embodiment of the present invention.

FIG. 2 shows a side view of a vehicle having a sensor set-up, in order to illustrate the method according to a second specific embodiment of the present invention.

FIG. 3 shows a side view of a vehicle having a sensor set-up, in order to illustrate the method according to a third specific embodiment of the present invention.

FIG. 4 shows a side view of a vehicle having a sensor set-up, in order to illustrate the method according to a fourth specific embodiment of the present invention.

FIG. 5 shows a side view of a vehicle having a sensor set-up, in order to illustrate the method according to a fifth specific embodiment of the present invention.

FIG. 6 shows a plan view of an ultrasonic sensor array.

### DETAILED DESCRIPTION OF EXAMPLE EMBODIMENTS

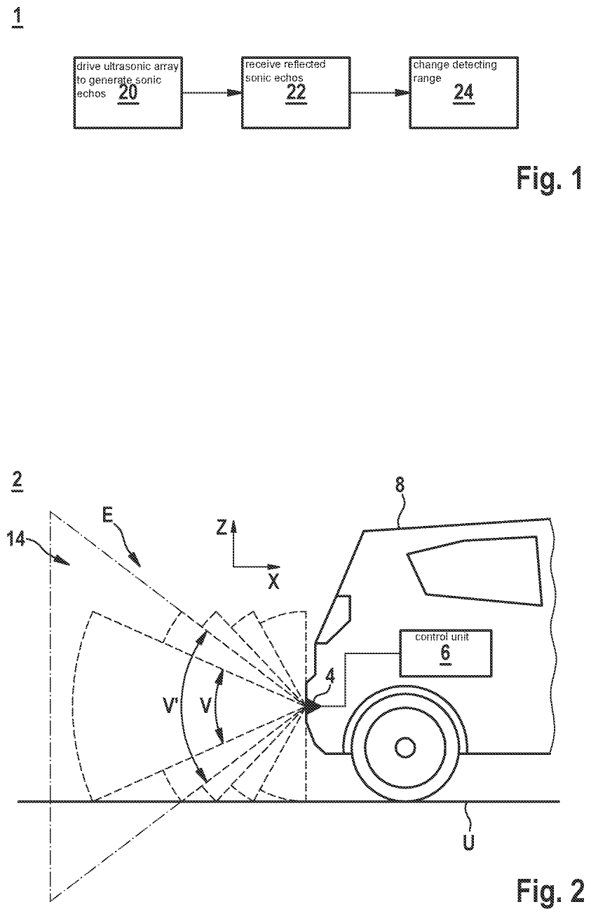

FIG. 1 shows a schematic flow chart for illustrating a method 1 according to a first specific embodiment. Method 1 is used for operating at least one ultrasonic sensor array 4. Ultrasonic sensor array 4 is illustrated, by way of example, as a part of a sensor set-up 2 on a vehicle, and is illustrated in FIGS. 2 through 5.

Method 1 may preferably be executed by a control unit 6, which is connected to at least one ultrasonic sensor array 4 in a manner allowing transmission of data and may take the form of part of the sensor set-up 2 on the vehicle, as well.

Control unit 6 may drive the ultrasonic sensor array to generate sonic echos and may also be used to receive measurement data generated by ultrasonic sensor array 4.

In a step 20, ultrasonic sensor array 4 is driven by control unit 6 to generate sonic echos. Sonic echos reflected from a detecting range E are received 22 by ultrasonic sensor array 4, in order to generate measurement data on the basis of the sonic echos received.

Ultrasonic sensor array 4 is preferably driven to generate and receive sonic echos in such a manner, that a horizontal and/or vertical solid angle H, V of a detecting range E is changed 24.

In this connection, solid angle H, V may be changed cyclically or continuously, in order to scan different distances and depths of detecting range E and/or of the scanning range, using sonic echos.

Solid angle H, V, which ultrasonic sensor array 4 scans, using sonic echos, and from which the reflected sonic echos are received, may be varied along a horizontal direction X and/or along a lateral direction Y and/or along a vertical direction Z. In the exemplary embodiment shown, horizontal direction X corresponds to a direction of travel of vehicle 8.

A solid angle H, V, into which ultrasonic sensor array 4 directs the sonic echos, and a solid angle H, V, from which ultrasonic sensor array 4 receives the reflected sonic echos, may preferably be equal to each other or differ from each other. The corresponding directional characteristic may be set and varied by control unit 6.

FIG. 2 shows a side view of a vehicle 8 having a sensor set-up 2, in order to illustrate the method 1 according to a second specific embodiment. For the sake of clarity, an ultrasonic sensor array 4 is positioned in the rear part of vehicle 8. However, ultrasonic sensor array 4 may be provided at any position and in any number. For example, ultrasonic sensor arrays 4, which are connected to control unit 6, may be positioned at corners of the vehicle and/or on the vehicle front end.

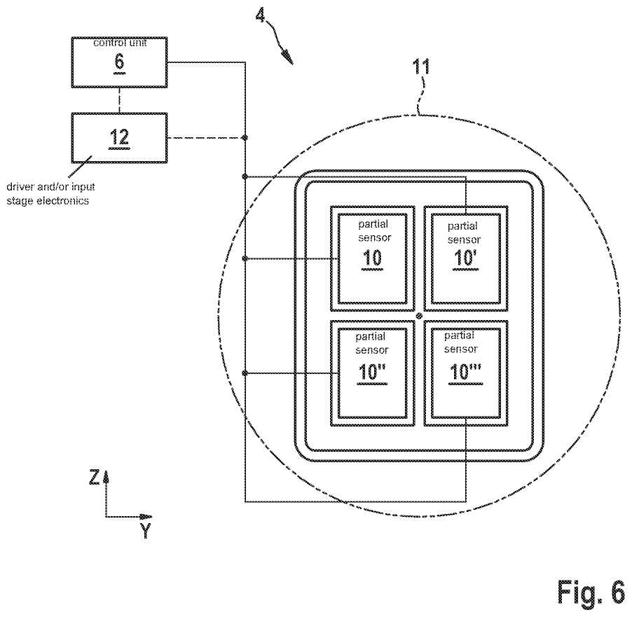

A plan view of an ultrasonic sensor array 4 is shown illustratively in FIG. 6. Such ultrasonic sensor arrays 4 are made up of a plurality of ultrasonic sensors and/or partial sensors 10, which are installed, for example, in a conventional housing 11. Such partial sensors 10 may be driven by control unit 6 independently of each other, to generate sonic echos and/or to receive reflected sonic echos. This may be accomplished directly by control unit 6 or by an interconnected driver and/or input stage electronics 12, e.g., for the amplification of the received signals or for the analog-to-digital conversion of the received signals. To illustrate the optional function of input stage electronics 12, they are connected to partial sensors 10 and control unit 6 by dashed connecting lines.

Control unit 6 may drive partial sensors 10 in such a manner, that, for example, objects O in the short range of vehicle 8, as well, interfere reliably, and without superimposition, with reflections of a surface U. To this end, the lower two partial sensors 10″, 10′″ may be used solely by control unit 6 for generating sonic echos, and the upper two partial sensors 10, 10′ and/or the lower two partial sensors 10″, 10′″ may be used for receiving reflected sonic echos.

The sonic echos are generated in the form of sonic waves and may be generated continuously or in pulsed form. In particular, a constant pulse width or a changeable pulse width of the generated sonic echos may be set by the control unit.

The use of ultrasonic sensor arrays 4 allows solid angle H, V of detecting range E to be changed as needed, so that detection gaps 14 are minimized. In the exemplary embodiment shown in FIG. 2, solid angle H, V, into which the sonic echos are directed, is reduced stepwise from a large solid angle H, V of, for example, 180°, in the direction of a smaller solid angle H, V, for example, 90°, in order to prevent objects O from being irradiated by ground reflections.

The detection gap may be reduced by a temporary opening of the opening angle, and/or even eliminated at a 1800 opening angle, see the following schematic illustration:

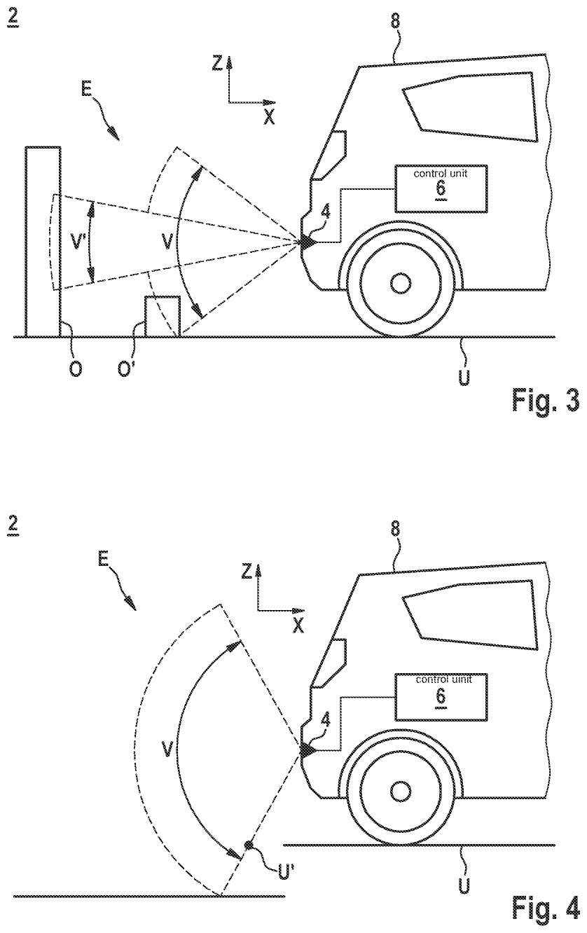

FIG. 3 shows a side view of a vehicle 8 having a sensor set-up 2, in order to illustrate the method 1 according to a third specific embodiment. Here, it is illustrated that on the basis of differently set solid angles H, H′, V, V′, objects O, O′ situated one behind the other may also be detected separately from each other.

In particular, objects O′, which have a small height and are still, for example, able to be driven over, may be distinguished from objects O, which have a greater height, for example, higher than a bumper of vehicle 8; and the former objects may be checked for plausibility.

FIG. 4 shows a side view of a vehicle 8 having a sensor set-up 2, in order to illustrate the method 1 according to a fourth specific embodiment. In this context, terracing of ground U is detected with the aid of a solid angle H, V set to be particularly wide. Consequently, the reflected sonic echos are not able to confirm an expected position of ground U′. Through this, using the method, terracing of ground U is registered by Substitute Specification control unit 6 on the basis of an evaluation of the measurement data of ultrasonic sensor array 4.

In the exemplary embodiments represented in FIGS. 2 through 4, the vertical component of solid angle V, V′ is shown for the sake of clarity. However, horizontal component H, H′ may be adjusted and/or changed by control unit 6 in a manner analogous to the vertical component of solid angle V, V′.

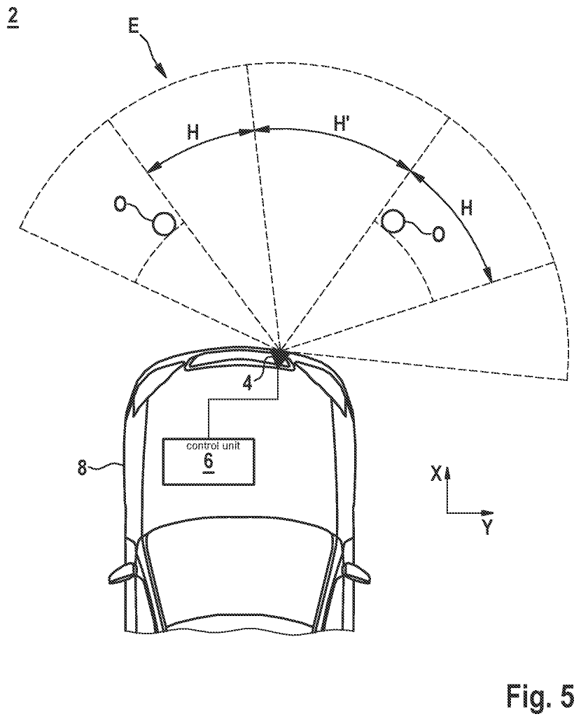

A side view of a vehicle 8 having a sensor set-up 2 is shown in FIG. 5, in order to illustrate the method 1 according to a fifth specific embodiment. In contrast to the exemplary embodiments already described, ultrasonic sensor array 4 is positioned on a front end of vehicle 8. The variation of the horizontal component of the solid angle H, H′ is illustrated. The horizontal component of solid angle H, H′ is varied by driving ultrasonic sensor array 4 with the aid of control unit 6. By this measure, for example, a plurality of objects O situated next to each other may be detected separately from each other.

In particular, objects, which lie at an equal distance from a conventional ultrasonic sensor, are normally not detected as separate objects.

By adjusting solid angle H, H′, a plurality of objects positioned next to each other may be distinguished on the basis of a plurality of measuring cycles using different solid angles V, H, V′, H′, and consequently, ambiguities may also be resolved.

The at least one ultrasonic sensor array 4 may be driven and operated by control unit 6 both during operation of vehicle 8 and in the shut-off and/or deactivated state of vehicle 8.

1-10. (canceled)

11. A method for operating at least one ultrasonic sensor array using a control unit, the method comprising:
driving the ultrasonic sensor array to generate sonic echos, and receiving reflected sonic echos by the ultrasonic sensor array, to generate measurement data based on the received sonic echos; and
driving the ultrasonic sensor array to generate and receive sonic echos, in such a manner, that a horizontal and/or vertical solid angle of a detecting range is changed.

12. The method as recited in claim 11, wherein the ultrasonic sensor array is driven to generate and receive sonic echos from the detecting range, using a wide solid angle and a subsequent, reduced solid angle.

13. The method as recited in claim 11, wherein the ultrasonic sensor array is driven to generate and receive sonic echos from the detecting range using a solid angle that varies in steps.

14. The method as recited in claim 11, wherein the ultrasonic sensor array is driven to generate and receive sonic echos from the detecting range, using a solid angle that varies continuously.

15. The method as recited in claim 14, wherein the different, continuously varied solid angles of the detecting range of the generated sonic echos overlap in sections; and using the generated measurement data, ascertained data from overlapping solid angles are excluded.

16. The method as recited in claim 11, wherein the solid angle is first changed, after the ultrasonic sensor array is driven to generate sonic echos and receives reflected sonic echos from a scanning range.

17. The method as recited in claim 11, wherein the solid angle of the detecting range is changed by a digitally adjustable directional characteristic of the ultrasonic sensor array.

18. A control unit configured to operate at least one ultrasonic sensor array, the control unit configured to:
drive the ultrasonic sensor array to generate sonic echos, and receive reflected sonic echos by the ultrasonic sensor array, to generate measurement data based on the received sonic echos; and
drive the ultrasonic sensor array to generate and receive sonic echos, in such a manner, that a horizontal and/or vertical solid angle of a detecting range is changed.

19. A non-transitory machine-readable storage medium on which is stored a computer program for operating at least one ultrasonic sensor array, the computer program, when executed by a computer, causing the computer to perform the following steps:
driving the ultrasonic sensor array to generate sonic echos, and receiving reflected sonic echos by the ultrasonic sensor array, to generate measurement data based on the received sonic echos; and
driving the ultrasonic sensor array to generate and receive sonic echos, in such a manner, that a horizontal and/or vertical solid angle of a detecting range is changed.
